(19) United States
(12) Patent Application Publication
(10) Pub. No.: US 2026/0125881 A1
(43) Pub. Date: May 7, 2026

(54) WATER RECYCLING SYSTEM

(71) Applicant: CASCADE WATER PRODUCTS LIMITED, Arbroath Angus (GB)

(72) Inventor: Peter HOLDSWORTH, Arbroath Angus (GB)

(73) Assignee: CASCADE WATER PRODUCTS LIMITED, Arbroath Angus (GB)

(21) Appl. No.: 19/119,631

(22) PCT Filed: Oct. 9, 2023
(86) PCT No.: PCT/GB2023/052615

§ 371 Date: Apr. 9, 2025

(30) Foreign Application Priority Data
Oct. 10, 2022 (GB) 2214884.5

(51) Int. Cl. E03B 1/04; C02F 9/00; C02F 103/00; E03B 7/07

(52) U.S. Cl. CPC E03B 1/044; C02F 9/00; E03B 7/072; C02F 2103/002; C02F 2209/005; C02F 2209/40; C02F 2301/043; E03B 2001/045

(57) ABSTRACT

A water recycling system for use in a premises comprises a filter system for receiving and filtering greywater; a storage tank for receiving and storing water from the filter system, the storage tank comprising a mains water inlet for receiving mains water; a distribution pump for pumping water from the storage tank to an end use; a control system for controlling operation of the system; and a plurality of flow meters in communication with the control system for measuring flow of water into and through the system and communicating flow data to the control system. A first flow meter is positioned to measure the flow of mains water entering the premises, a second flow meter is positioned to measure the flow of mains water entering the storage tank, and a third flow meter is positioned to measure the flow of water entering the storage tank from the filter system.

The present invention relates to a water recycling system, and in particular to a system for recycling greywater.

Greywater (also spelled graywater, grey water, gray water, and sometimes referred to as sullage) refers to wastewater generated in households and office buildings from streams without faecal contamination, i.e. all streams except for wastewater from toilets. Sources of greywater include, sinks, showers, baths, washing machines and dishwashers. Greywater contains fewer pathogens than domestic wastewater, and is generally safer and easier to handle, treat and reuse onsite, for example for toilet flushing, landscape or crop irrigation, and other non-potable uses.

Greywater reuse in urban water systems provides substantial benefits for both the water supply subsystem, by reducing the demand for fresh, clean water, as well as the wastewater subsystems, by reducing the amount of wastewater required to be conveyed and treated.

Complex, whole-building solutions and small-scale domestic systems are known, but there is a need for cheaper micro systems which can be retrofitted in commercial and domestic settings, to effectively reduce costs, energy and water usage. There is also a need for a water recycling system which can provide users with data regarding volumes of water recycled and used.

The present invention seeks to provide a water recycling system which can meet these needs.

Thus, according to the present invention in a first aspect there is provided a water recycling system for use in a premises which comprises a filter system for receiving greywater from a greywater source and filtering the greywater; a storage tank for receiving and storing water from the filter system, the storage tank comprising a mains water inlet for receiving mains water; a distribution pump for pumping water from the storage tank to an end use; a control system for controlling operation of the system; and a plurality of flow meters in communication with the control system for measuring flow of water into and through the system and communicating flow data to the control system; wherein a first flow meter is positioned to measure the flow of mains water entering the premises, a second flow meter is positioned to measure the flow of mains water entering the storage tank, and a third flow meter is positioned to measure the flow of water entering the storage tank from the filter system.

The present invention thus provides a water recycling system for use in a premises, such as a domestic dwelling, an office, hotel, school, and the like. The system s for receiving and recycling greywater from greywater sources, such as a sink, shower, bath, washing machine and dishwasher, for non-potable uses, such as toilet flushing.

The system of the present invention comprises a filter system for receiving greywater from a greywater source and filtering the greywater to remove particulates and other unwanted matter, such as hair, before it passes to the storage tank. The filter system preferably comprises a greywater inlet for receiving greywater from a greywater source, a greywater outlet for passing filtered greywater to the storage tank, and may also comprise one or more drainage outlets.

The filter system preferably comprises a first filter having a first average mesh or pore size for receiving water from the greywater inlet. Thus, greywater entering the system is initially filtered by the first filter. In preferred embodiments, the purpose of the first filter is to filter out larger particulates and other unwanted debris, such as hair.

The filter system preferably further comprises a second filter having a second average mesh or pore size for receiving water from the first filter, the second average mesh or pore size being smaller than the first average mesh or pore size. In preferred embodiments, the purpose of the second filter is to filter out particulates which passed through the first filter.

The filter system used in the water recycling system of the present invention thus preferably comprises a sequence of filters of decreasing mesh or pore size in fluid communication connected in series. Whilst preferred embodiments of the system of the first aspect of the present invention comprise first and second filters, additional filters may be used.

Preferably at least one, and more preferably both, of the first and second filters comprises a housing having an inner volume and an outer volume surrounding and in fluid communication with the inner volume. Greywater entering the filter passes firstly into the inner volume, then through a filter medium, and then into the outer volume. The filtered greywater then passes out of the filter from the outer volume, e.g. to a further filter or the storage tank.

The inner volume may contain a duct (e.g. a pipe) through which greywater enters the filter. The duct preferably enters the filter at or towards the top of the filter, so that greywater may enter the filter under gravity, and extends downwardly within the inner volume, such that greywater exits the duct towards the bottom of the filter.

Filter material is preferably positioned between the inner volume and the outer volume, so that greywater passing from the inner volume to the outer volume must pass through and is filtered by the filter material. In preferred embodiments the filter comprises a tubular (e.g. cylindrical) body made from or containing filter material, which defines the inner and outer volumes, i.e. the inner volume is the volume defined by the inner surface of the tubular body, and the outer volume is the volume between the outer surface of the tubular body and the filter housing. In preferred embodiments, the tubular body of or containing filter material forms a water-tight seal with the inner surfaces of the filter housing, such that water can only pass from the inner to the outer volume via the filter material. As described above, in preferred embodiments greywater preferably exits the inner duct at or towards the bottom of the filter; however, the duct may preferably comprise small openings along its length to permit small volumes of greywater to pass out of the duct and through the filter material along its length, which helps to keep the filter material clean.

As described herein, preferably the or each filter comprises an inner and outer volume, separated by filter material, such that in use greywater can enter the filter into the inner volume, then pass through the filter material into the outer volume, and then exit the filter. Thus, in preferred embodiments in which both the first and second filters comprise an inner and outer volume, the system inlet opens into the first filter inner volume, greywater exits the first filter outer volume into the second filter inner volume, and greywater exits the second filter outer volume into the storage tank. The storage tank can store water which has passed through the first and second filters until it is needed for use, for example to flush a toilet.

The use of inner and outer volumes in the filters allows the water in the filters time to settle out, for small solids to gravitate to the bottom, and for soap residue to dissipate. In this way, greywater entering the storage tank from the filter system may have a significantly reduced soap and foam content.

As described herein, in preferred embodiments the filter inlets are positioned at the top of the filters, such that greywater can fill the filters under gravity, which allows more time for solids in the greywater to settle to the bottom of the filters.

Preferably, the filter outlets are positioned such that greywater only passes through when the filters are substantially full of water. Thus, in the preferred embodiments described herein, greywater preferably only passes from the first filter into the second filter when the first filter is substantially full, and preferably only passes from the second filter into the storage tank when the second filter is substantially full.

The filter system preferably comprises one or more drainage outlets for allowing settled particles to be removed, to prevent build-up of said particles. The drainage outlets are conveniently positioned in the bottom of each filter, and may be opened and closed by a valve, such as a solenoid or rotary valve. The valves are preferably controlled by the control system, to open at predetermined intervals for a predetermined period of time. For example, the drainage valves may open for a period of a few seconds or longer, for example 10 seconds to a minute, such as 30 seconds, every few days or longer, for example every other day, every three days, or once a week. In preferred embodiments the drainage outlet of the first filter opens every 72 hours for approximately 20 seconds, to back flush water through the filter material and remove sedimentation. In preferred embodiments, the drainage outlet of the second filter opens every 72 hours for 25 seconds to back flush water through the filter material and remove sedimentation. Preferably each filter in the filter system comprises a drainage outlet.

As described herein, the filter system preferably comprises first and second filters in series. In such embodiments, the first filter comprises filter material suitable for filtering out larger particulates and other unwanted debris, such as hair. A preferred filter material for the first filter is reticulated foam. Reticulated foam is a porous, low density solid foam having an open structure, and normally comprises an organic polymer such as polyurethane, but may comprise other materials such as ceramics or metals. The open-cell structure of the foam is quick-drying and allows for high water throughput. Reticulated foams are normally characterised by “ppi”, i.e. the number of pores per inch: the higher the ppi the smaller the pore size. The pore sizes typically vary from 4 ppi (very coarse) to 110 ppi (very fine), for example 10 ppi, 20 ppi, 30 ppi, 45 ppi, 60 ppi, 75 ppi, 80 ppi, 90 ppi and 100 ppi. In SI units, 10 ppi equates to an average pore size of approximately 2.54 mm, and 100 ppi an average pore size of approximately 0.254 mm. Reticulated foam density may be in the range of from 20 to 30 kg/m3.

As described herein, the filter system preferably further comprises a second filter having a second average mesh or pore size for receiving water from the first filter, the second average mesh or pore size being smaller than the first average mesh or pore size. In preferred embodiments, the purpose of the second filter is to filter out particulates which passed through the first filter. Thus, the second filter may comprise a mesh of a suitable mesh size, for example 10 to 200 82 m, such as 50 to 100 82 m mesh. A preferred mesh size for the second filter is 60 82 m.

The filter system filters may be cleaned through a purge, i.e. an emptying of water from the filter system. A purge of one or more of the filters may be triggered, for example, as a consequence of a lack of water entering the system, an overflow of water from the system, as a regular event occurring at predetermined times, or in response to a manual request. The filter is preferably arranged such that when the filter system is purged, water in the outer volume flows back through the filter material into the inner volume, thus dislodging solids which have built up on the filter. For example, the filter drainage outlet may be connected to the inner volume of the filter. In addition, the filters may be cleaned by pumping water through them from, for example, the storage tank, or a toilet flushing tank, either as a regular event occurring at predetermined times, or in response to a manual request.

The water recycling system of the first aspect of the present invention comprises a storage tank for receiving greywater from the filter system, and storing filtered greywater for use. In use, the storage tank will preferably always contain sufficient water to flush a toilet, more preferably sufficient water for a plurality of flushes. Thus, the storage tank preferably comprises one more sensors to sense the water level in the storage tank. If the water level in the storage tank drops to a predetermined minimum level, then water held within the filter system may be transferred to top-up the water level in the storage tank, for example by opening a valve in the filter system and allowing the water to flow into the storage tank under gravity or by a pump. For example, a low water level sensor might trigger a valve to open and optionally a pump to operate to transfer water from the filter system to the storage tank for a predetermined period of time, or until the water level in the storage tank increases to a predetermined level, for example as detected by a further sensor. Operation of the low water level sensor preferably disables the distribution pump until the water level in the storage tank rises to a sufficient level, to prevent air locks in the system.

The storage tank comprises a mains water inlet for receiving mains water, to allow the storage tank to be topped up with water. For example, if there is insufficient water in the filter system to top-up the water in the storage tank, as described above, then the mains water inlet may be opened to allow mains water to top-up the water in the storage tank, to ensure that there is always sufficient water held in the storage tank to provide a predetermined number of toilet flushes. A toilet flush may use for example 5-6 litres of water, so, for example, sufficient top-up water for three toilet flushes would approximate to 15-20 litres of water. For example, a low water level sensor might trigger a valve to open and optionally a pump to operate to allow mains water to flow into the storage tank for a predetermined period of time, or until the water level in the storage tank increases to a predetermined level, for example as detected by a further sensor.

The storage tank may contain a float valve (such as a ballcock) for triggering the opening of one or more valves to top-up water in the tank, for example from either the filter system and/or mains water, to ensure that a minimum volume of water is stored within the system at any given time.

The system of the present invention preferably comprises one storage tank, but may comprise more than one storage tank in fluid communication connected in series.

The storage tank preferably further comprises an overflow sensor, for sensing water which is overflowing from the system and thus that the system is full, i.e. the filter system and the storage tank. The overflow sensor is thus preferably positioned at the top of the storage tank or, if the system comprises more than one storage tank, the most downstream tank in the series, for example in an overflow pipe. If the system is overflowing, then more water is entering the system than is leaving, which indicates that the water stored within the system may be old and require replacing to reduce bacterial growth. Thus, the system is preferably arranged so that when the overflow sensor senses water flowing for a predetermined period of time, for example 10-20 (e.g. 15) seconds, then a partial or complete purge of the filter system and/or the storage tank is triggered, for example a partial (e.g. for a predetermined duration, e.g. 10-30 (e.g. 20) seconds), or complete purge of the filter system. This allows older water to be removed, to be replaced by water entering the system through the inlet. In preferred embodiments, when the overflow switch is operated, the control system triggers a cleaning cycle, in which the second filter drainage outlet is opened for a predetermined time period (for example 10-30 (e.g. 20) seconds) and the storage tank drainage outlet is also opened for a predetermined time period (for example 10-20 (e.g. 15) seconds). If the overflow switch operates again, then the first filter drainage outlet is opened for a predetermined time period (for example 10-30 (e.g. 20) seconds) and the storage tank drainage outlet is also opened for a predetermined time period (for example 10-20 (e.g. 15) seconds). This cycle preferably repeats as long as the overflow sensor detects an overflow of water from the system.

The storage tank preferably comprises a drainage outlet for allowing settled particles to be removed, to prevent build-up of said particles. The drainage outlet i conveniently positioned in the bottom of the tank, and may be opened and closed by a valve, such as a solenoid or rotary valve. The valve is preferably controlled by the control system, to open at predetermined intervals for a predetermined period of time. For example, the drainage valve may open for a period of a few seconds or longer, for example 10 seconds to a minute, such as 30 seconds, every few days or longer, for example every other day, every three days, or once a week. In preferred embodiments, the drainage outlet of the storage tank opens every 72 hours for 35 seconds to remove sedimentation.

The water recycling system of the first aspect of the present invention preferably further comprises a distribution pump for pumping water from the storage tank to the end use, for example a toilet. The distribution pump may be any suitable pump, for example operating at 1-2 bar pressure, and is preferably controlled by the control system.

The water recycling system of the first aspect of the present invention preferably comprises a further outlet filter between the distribution pump and the end use. The outlet filter may be of a similar construction to the filters described herein for the filter system, and preferably comprises a filter material having an average mesh or pore size which is smaller than that of the filter system. Thus, for example, the outlet filter may comprise a filter material having an average mesh size of from 1 to 10 82 m, for example 5 82 m. The outlet filter may more preferably comprise an ultrafiltration unit. Ultrafiltration is a type of membrane filtration in which liquid is typically forced across a partially permeable membrane. Suspended solids and higher molecular weight solutes are removed in the retentate (i.e. the fraction of the feed which does not pass through the membrane of the ultrafiltration unit), with the solvent (e.g. water) and lower molecular weight solutes passing through the membrane in the permeate (i.e. the fraction of the feed which does pass through the membrane of the ultrafiltration unit). Ultrafiltration membranes are generally defined by the molecular weight cut-off (MWCO) of the membrane used, or the membrane pore size. A typical ultrafiltration membrane pore size may be approximately 0.01×10⁻⁶ m (micron). In the system of the present invention, the particular ultrafiltration membrane(s) to be used in the outlet filter will depend on factors such as the source of the water, the solids content, and particle size distribution, as will be understood by a person skilled in the art.

In preferred embodiments, water is thus pumped through the outlet filter (as opposed to the filter system filters, in through which water is preferably passed under gravity, as described herein). Water preferably exits the outlet filter at or towards the top of the outlet filter, i.e. only when the outlet filter is substantially full of water.

The outlet filter preferably comprises a drainage valve for allowing settled particles to be removed, to prevent build-up of said particles. The drainage valve is conveniently positioned at the bottom of the outlet filter, and is preferably controlled by the control system, to open at predetermined intervals for a predetermined period of time. For example, the drainage valve may open for a period of a few seconds or longer, for example 10 seconds to a minute, such as 20 or 30 seconds, every few days or longer, for example every other day, every three days, or once a week. In preferred embodiments, the drainage outlet of the outlet filter opens every 72 hours for 20 seconds to remove sedimentation.

The water recycling system of the first aspect of the present invention preferably further comprises a pressure switch to measure water pressure exiting the system, in communication with the control system. Thus, for example, when a toilet is flushed the pressure switch will detect a drop in water pressure, which is communicated to the control system. The control system may then activate the distribution pump to pump water from the storage tank to the end use, e.g. to the toilet, to restore the water pressure. In preferred embodiments, the pressure switch is positioned downstream of the outlet filter. The pressure switch may be disabled when the low level water sensor is operated.

The water recycling system of the first aspect of the present invention preferably further comprises a UV light unit through which water passes between the outlet filter and the end use. The UV unit helps to further purify the water, reducing microbiological contamination, and may comprise a neon UV light. The UV unit may, for example, allow for a flow rate of 15 litres per minute. In the preferred embodiments described above, the UV unit may operate, preferably through activation by the control system, when the pressure switch detects a drop in water pressure, for example due to a toilet being flushed.

The water recycling system of the first aspect of the present invention further comprises a plurality of flow meters in communication with the control system for measuring flow of water into and through the system and communicating flow data to the control system, wherein a first flow meter is positioned to measure the flow of mains water entering the premises, a second flow meter is positioned to measure the flow of mains water entering the storage tank, and a third flow meter is positioned to measure the flow of greywater entering the storage tank from the filter system.

Thus, the first flow meter is positioned to measure the flow of mains water entering the premises in which the water recycling system is located. For example, the first flow meter may be positioned at the stop tap where water enters the premises from the mains supply. This flow meter informs the user how much water is entering the premises from the mains supply.

The second flow meter is positioned to measure the flow of mains water entering the storage tank. For example, the second flow meter may be positioned upstream of the mains water inlet for the storage tank. This flow meter informs the user how much water is being used by the water recycling system from the mains supply.

The third flow meter is positioned to measure the flow of greywater entering the storage tank from the filter system. Thus, in preferred embodiments described herein, the third flow meter may be positioned between the second filter and the storage tank. This flow meter informs the user how much greywater is entering the storage tank of the system, i.e. the amount of greywater being saved.

Each of the flow meters is in communication with the control system to provide the user with feedback regarding the flow of water into and through the system, as is described in more detail below.

The water recycling system of the first aspect of the present invention preferably further comprises dosing means for dosing greywater entering the system with a chemical agent, such as a cleansing or purifying agent, for example an antibacterial agent or biocide. In this s way, greywater entering the system may be pre-treated to kill bacteria and remove other impurities.

Dosing with a chemical agent may be triggered by an inlet sensor, and the system of the present invention thus preferably further comprises an inlet sensor, to sense water entering the system. The inlet sensor is thus conveniently positioned upstream from the filter system.

The amount of chemical agent to be added to the greywater entering the system depends, in part, on the flow rate of water. For example, the operation of a shower may cause a relatively low flow rate of water, whereas discharging a bath may result in a relatively high flow rate of water. The inlet sensor thus preferably senses the flow rate of greywater entering the system. In a preferred embodiment, the inlet sensor comprises a frequency driven flow meter, which generates a signal according to the flow rate and communicates with the control system to deliver an appropriate amount of chemical agent for that flow rate. For example, the flow meter may be configured to sense “low”, “medium” and “high” flow rates.

### The Dose of Agent to Be Released Will Depend Upon

the agent in question and the desired result, but will typically be from 1 to 20 ppm, for example 10 ppm, of greywater (for example, 0.005 ml of agent per litre of greywater).

In addition, the inlet sensor may be used to trigger a purge of the system if no water at all is detected entering the system for a predetermined period of time, for example period of a few hours to a few days, e.g. 24-36 hours. The inlet sensor can thus be used to trigger partial or complete emptying the filter system and/or the storage tank in the system in the event that it detects no water for a predetermined period of time. Preferably, a total system purge is followed by the storage tank being filled with water from an alternative source, such as mains water, so it will contain sufficient water for a predetermined number of toilet flushes.

The water recycling system of the present invention further preferably comprises a bypass valve at the system inlet which can be operated to bypass the system entirely, so that all greywater flows directly to waste. This may be necessary or desirable, for example, to prevent heavily contaminated water from entering the system, or in the event of a system failure. The bypass valve may be operated by a user remotely, for example via a remote switch. For example, a remote switch may be positioned in the bathroom of a premises. Pressing the remote switch may open the bypass valve for a predetermined period of time, for example 10 minutes. In the event of the bypass valve being opened by the control system due to a system fault, the bypass valve preferably remains open until the fault has been rectified.

The water recycling system of the first aspect of the present invention comprises a control system for controlling operation of the system. The control system may be set up or programmed to perform certain actions at regular time intervals, such as a regular partial or complete purge of the filter system and/or storage tank for the removal of settled solids; other actions in response to activation of a sensor, such as the inlet flow sensor, water level sensor, and overflow sensor described above; or actions in response to ad hoc manual requests, such as an emergency partial or complete purge of the system in the event of contamination, or system shutdown.

The flow meters communicate with the control system, and provide flow data to the system. The control system may comprise a user interface, such as a display, for presenting the flow data to a user. The control system may store the data, and may be accessible by a user via a remote device, for example a mobile device such as a phone or tablet using appropriate application software. For example, the display may show the amount of greywater saved by the system, the amount of potable water used by the system, and/or the potable water entering the premises. The control system may provide the user with information regarding the condition of the system, such as chemical agent/biocide levels, mains water pressure, and failure conditions.

The control system is preferably configured to perform certain actions in the event of a system failure. For example, the main bypass valve may be operated, to bypass all greywater directly to waste. The fail condition may be triggered if the chemical agent/biocide reservoir is empty, if no mains water pressure is detected as a back-up, or in the event of failure of the distribution pump.

The control system may be configured to shut down the system for a predetermined period on demand by a user, for example in the event that the system will not be used for a period of time (e.g. the user is going on holiday), for example three or more days. In the event that the user initiates a temporary system shut down, the control system may be configured to empty the filter system and the storage tank, and open the mains water inlet to the storage tank to clean the tank and fill it to the minimum level for the desired end use, e.g. for the toilets to flush. The main bypass valve will also open. When desired, such as on returning from holiday, the user can cancel the temporary system shut down, and the control system returns the water recycling system to normal operation.

As described above, water stored in the storage tank is suitable for any non-potable use, and is particularly suitable for use in flushing toilets. Thus, water held in the storage tank may be pumped from the storage tank into the flushing tank of a toilet.

The various components of the system of the present invention may be made from any suitable components, such as pipes of suitable diameter and thickness, and tanks of suitable volumes. For example, the first and second filters may each have a volume of from 20 to 30 litres each, for example 25 or 28 litres. The storage tank may have a volume, for example, of 75 to 100 litres. For example, a storage tank having dimensions of 525×200×850 mm will have a volume of approximately 89.25 litres. The low water level sensor described above in the storage tank may be positioned, for example, so that it is triggered when the water level in the tank has decreased to, for example, 50% of the maximum volume of the tank.

Thus, in use of preferred embodiments of the system of the present invention, greywater may flow from a bath or shower through the inlet sensor. The greywater may have already passed through a suitable filter prior to arriving at the inlet sensor assembly. The inlet sensor assembly triggers dosing of the greywater with a suitable amount of chemical agent according to the flow rate of the water which is sensed. The dosed greywater flows into the inner volume of the first filter and, as the first filter fills, water passes through the first filter filter material, into the outer volume, and then out of the outlet in the first filter outer volume and into the inner volume of the second filter. The water then passes through the second filter filter material, into the second filter outer volume, and as the second filter continues to fill, water passes out of the outlet in the second filter outer volume, and into the storage tank. If there is more than one storage tank, then as the first storage tank fills the water passes out of the first storage tank into the second storage tank, and from the second to the third, and so forth. One or more of the storage tanks in the series may be in fluid communication with the end use of the water, for example a toilet. A low level sensor in the storage tank may sense when the water level decreases to a predetermined level, for example 50% of the storage tank volume, which may trigger the control system to release water from the filter system to top-up the storage tank. Additionally or alternatively, water from another source, such as mains water, may be used to top up the storage tank, to ensure that water is always available for the end use. An overflow sensor may sense when the system is full, and trigger the control system to partially or completely purge “old” water from the system, to be replaced with “new” water, to reduce bacterial growth.

An embodiment of the water recycling system of the first aspect of the present invention will now be described in detail with reference to the accompanying drawings, in which:

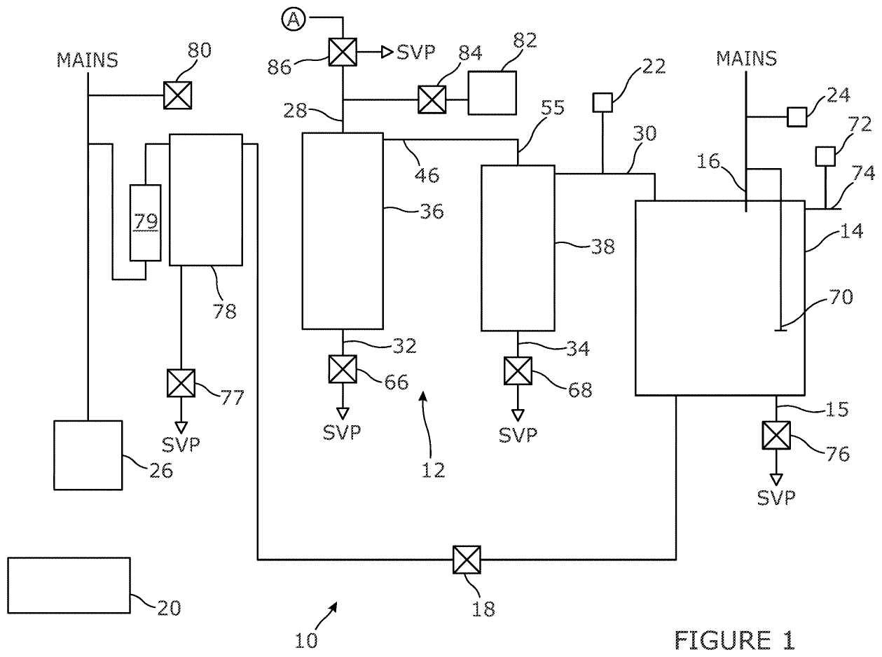

FIG. 1 is a schematic drawing of an embodiment of a water recycling system of the first aspect of the present invention; and

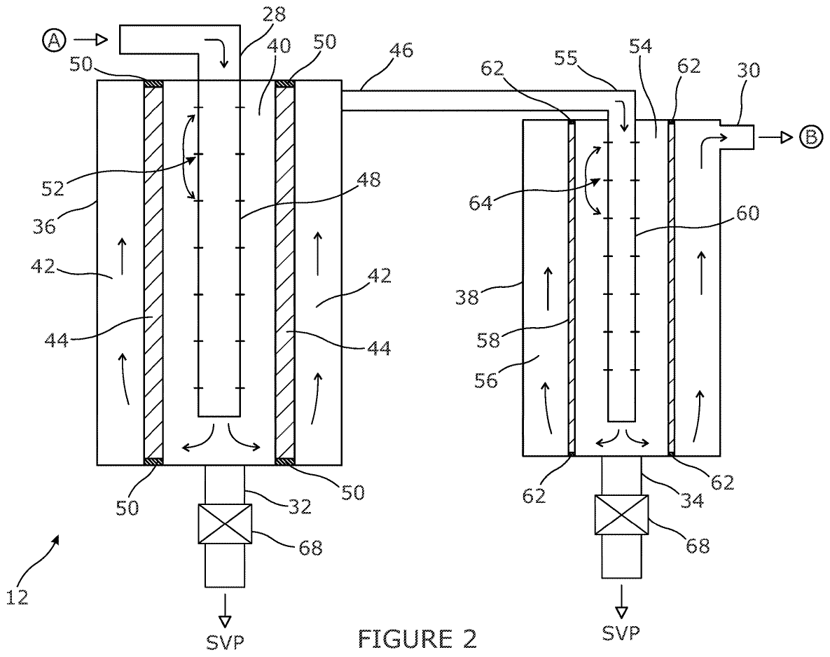

FIG. 2 is a schematic drawing showing the filter system and storage tank of the water recycling system shown in FIG. 1 in more detail.

Thus, the water recycling system 10 for use in a premises comprises a filter system 12 for receiving greywater from a greywater source, as indicated by arrow A, and filtering the greywater; a storage tank 14 for receiving and storing water from the filter system 12, the storage tank 14 comprising a mains water inlet 16 for receiving mains water and a drainage outlet 15; a distribution pump 18 for pumping water from the storage tank 14 to an end use; a control system 20 for controlling operation of the system 10; and a plurality of flow meters 22, 24 in communication with the control system 20 for measuring flow of water into and through the system 10 and communicating flow data to the control system 20; wherein a first flow meter (not shown in the Figures) is positioned to measure the flow of mains water entering the premises, a second flow meter 24 is positioned to measure the flow of mains water entering the storage tank 14, and a third flow meter 22 is positioned to measure the flow of water entering the storage tank 14 from the filter system 12.

The greywater source A may be for example a sink, shower, bath, washing machine and dishwasher, for non-potable uses, such as toilet flushing. A toilet is indicated in FIG. 1 by reference 26.

The filter system 12 comprises a greywater inlet 28 for receiving greywater from a greywater source A, a greywater outlet 30 for passing filtered greywater to the storage tank, and comprises drainage outlets 32, 34.

The filter system 12 is shown in more detail in FIG. 2, and comprises a first filter 36 having a first average mesh or pore size for receiving water from the greywater inlet 28. Thus, greywater A entering the system 10 is initially filtered by the first filter 36.

The filter system 12 comprises a second filter 38 having a second average mesh or pore size for receiving water from the first filter 36, the second average mesh or pore size being smaller than the first average mesh or pore size.

The filter system 12 thus comprises a sequence of first 36 and second 38 filters of decreasing mesh or pore size in fluid communication connected in series.

The first filter 36 has an inner volume 40 and an outer volume 42 surrounding and in fluid communication with the inner volume 40. Greywater entering the first filter 36 passes firstly into the inner volume 40, then through a filter medium 44, and then into the outer volume 42. The filtered greywater then passes out of the first filter 36 from the outer volume 42 via the first filter outlet 46 to the second filter 38.

The inner volume 40 contains a duct 48 through which greywater enters the first filter 36. The duct 48 enters the first filter 36 at the top of the filter 36, so that greywater enters the filter 36 under gravity, and extends downwardly within the inner volume 40, such that greywater exits the duct 48 towards the bottom of the filter 36.

The flow of water through the filter system is indicated in FIG. 2 by the arrows.

Filter material 44 is positioned between the inner volume 40 and the outer volume 42, so that greywater passing from the inner volume 40 to the outer volume 42 must pass through and is filtered by the filter material 44. The filter comprises a tubular (e.g. cylindrical) body made from or containing the filter material 44, which defines the inner 40 and outer 42 volumes, i.e. the inner volume 40 is the volume defined by the inner surface of the tubular body, and the outer volume 42 is the volume between the outer surface of the tubular body and the filter housing. The tubular body of or containing filter material 44 forms a water-tight seal where indicated by reference 50 with the inner surfaces of the filter housing, such that water can only pass from the inner 40 to the outer volume 42 via the filter material 44. Greywater exits the duct 48 at or towards the bottom of the filter 36. The duct 48 comprises small openings 52 (only some of which are identified by reference numbers for clarity purposes) along its length to permit small volumes of greywater to pass out of the duct 48 and through the filter material 44 along its length, which helps to keep the filter material 44 clean.

Similarly, the second filter 38 has an inner volume 54 and an outer volume 56 surrounding and in fluid communication with the inner volume 54. Greywater entering the second filter 38 from the first filter 36 passes firstly into the inner volume 54 through second filter inlet 55, then through a filter medium 58, and then into the outer volume 56. The filtered greywater then passes out of the second filter 38 from the outer volume 56 via the filter system outlet 30 to the storage tank (not shown in FIG. 2), as indicated by arrow B.

The inner volume 54 contains a duct 60 through which greywater enters the second filter 38. The duct 60 enters the second filter 38 at the top of the filter 38, so that greywater enters the filter 38 under gravity, and extends downwardly within the inner volume 54, such that greywater exits the duct 60 towards the bottom of the filter 38.

Filter material 58 is positioned between the inner volume 54 and the outer volume 56, so that greywater passing from the inner volume 54 to the outer volume 56 must pass through and is filtered by the filter material 58. The filter comprises a tubular (e.g. cylindrical) body made from or containing the filter material 58, which defines the inner 54 and outer 56 volumes, i.e. the inner volume 54 is the volume defined by the inner surface of the tubular body, and the outer volume 56 is the volume between the outer surface of the tubular body and the filter housing. The tubular body of or containing filter material 58 forms a water-tight seal where indicated by reference 62 with the inner surfaces of the filter housing, such that water can only pass from the inner 5 to the outer volume 56 via the filter material 58. Greywater exits the duct 60 at or towards the bottom of the filter 38. The duct 60 comprises small openings 64 along its length (only some of which are identified by reference numbers for clarity purposes) to permit small volumes of greywater to pass out of the duct 60 and through the filter material 58 along its length, which helps to keep the filter material 58 clean.

Thus, the system inlet 28 opens into the first filter inner volume 40, greywater exits the first filter outer volume 42 into the second filter inner volume 54, and greywater exits the second filter outer volume 56 into the storage tank 14 (not shown in FIG. 2). The storage tank 14 can store water which has passed through the first 36 and second 38 filters until it is needed for use, for example to flush a toilet 26.

The filter outlets 46, 30 are positioned such that greywater only passes through when the filters 36, 38 are substantially full of water. Thus, in the preferred embodiments described herein, greywater only passes from the first filter 36 into the second filter 38 when the first filter 36 is substantially full, and only passes from the second filter 38 into the storage tank 14 when the second filter 38 is substantially full.

Each of the first 36 and second 38 filters comprises a drainage outlet 32 and 34 respectively for allowing settled particles to be removed, to prevent build-up of said particles. The drainage outlets 32, 34 are positioned in the bottom of each filter 36, 38, and may be opened and closed by a valve 66, 68 respectively, such as a solenoid or rotary valve. The valves 66, 68 are preferably controlled by the control system 20, to open at predetermined intervals for a predetermined period of time. For example, the drainage valves 66, 68 may open for a period of a few seconds or longer, for example 10 seconds to a minute, such as 30 seconds, every few days or longer, for example every other day, every three days, or once a week. In preferred embodiments the drainage outlet 66 of the first filter 36 opens every 72 hours for approximately 20 seconds, to back flush water through the filter material 44 and remove sedimentation. In preferred embodiments, the drainage outlet of the second filter 38 opens every 72 hours for 25 seconds to back flush water through the filter material 58 and remove sedimentation.

The first filter 36 comprises filter material 44 suitable for filtering out larger particulates and other unwanted debris, such as hair. A preferred filter material for the first filter is reticulated foam as described herein.

The second filter 38 comprises filter material 58 which has a mesh or pore size which is smaller than the average mesh or pore size of the first filter material 44. The purpose of the second filter 38 is to filter out particulates which passed through the first filter 36. Thus the second filter may comprise a mesh of a suitable mesh size as described herein.

The filter system filters 36, 38 may be cleaned through a purge, i.e. an emptying of water from the filter system 12. A purge of one or more of the filters 36, 38 may be triggered, for example, as a consequence of a lack of water entering the system 10, an overflow of water from the system 10, as a regular event occurring at predetermined times, or in response to a manual request. Each filter 36, 38 is arranged such that when the filter system is purged, water in the outer volume 42, 56 flows back through the filter material 44, 58 into the inner volume 40, 54, thus dislodging solids which have built up on the filter 36, 38. The filter drainage outlet 32, 34 is connected to the inner volume 40, 54 of the filter 36, 38. In addition, the filters 36, 38 may be cleaned by pumping water through them from, for example, the storage tank 14, or a toilet 26 flushing tank, either as a regular event occurring at predetermined times, or in response to a manual request.

The illustrated water recycling system 10 comprises a storage tank 14 for receiving greywater from the filter system 12, and storing filtered greywater for use. In use, the storage tank 14 will preferably always contain sufficient water to flush a toilet, more preferably sufficient water for a plurality of flushes. Thus, the storage tank 14 comprises one or more sensors (not shown) to sense the water level in the storage tank 14. If the water level in the storage tank 14 drops to a predetermined minimum level, then water held within the filter system 12 may be transferred to top-up the water level in the storage tank 14.

The storage tank 14 comprises a mains water inlet 16 for receiving mains water, to allow the storage tank to be topped up with water. For example, if there is insufficient water in the filter system 12 to top-up the water in the storage tank 14, as described above, then the mains water inlet 16 may be opened to allow mains water to top-up the water in the storage tank 14, to ensure that there is always sufficient water held in the storage tank 14 to provide a predetermined number of toilet flushes. A toilet flush may use for example 5-6 litres of water, so, for example, sufficient top-up water for three toilet flushes would approximate to 15-20 litres of water.

The storage tank may contain a float valve 70 (such as a ballcock) for triggering the opening of one or more valves to top-up water in the tank, for example from either the filter system 12 and/or mains water, to ensure that a minimum volume of water is stored within the system 10 at any given time.

The illustrated system 10 comprises one storage tank 14, but systems of the present invention may comprise more than one storage tank in fluid communication connected in series.

The storage tank 14 comprises an overflow sensor 72, for sensing water which is overflowing from the system 10 and thus that the system 10 is full, i.e. the filter system 12 and the storage tank 14. The overflow sensor 72 is positioned at the top of the storage tank 14 in an overflow pipe 74. The system 10 is arranged so that when the overflow sensor 72 senses water flowing for a predetermined period of time, for example 10-20 (e.g. 15) seconds, then a partial or complete purge of the filter system 12 and/or the storage tank 14 is triggered, for example a partial (e.g. for a predetermined duration, e.g. 10-30 (e.g. 20) seconds), or complete purge of the filter system 12. This allows older water to be removed, to be replaced by water entering the system 10 through the inlet 28. When the overflow sensor is triggered, the control system 20 preferably triggers a cleaning cycle, in which the second filter drainage outlet 34 is opened for a predetermined time period (for example 10-30 (e.g. 20) seconds) and the storage tank drainage outlet 15 is also opened for a predetermined time period (for example 10-20 (e.g. 15) seconds). If the overflow sensor 72 operates again, then the first filter drainage outlet 32 is opened for a predetermined time period (for example 10-30 (e.g. 20) seconds) and the storage tank drainage outlet 15 is also opened for a predetermined time period (for example 10-20 (e.g. 15) seconds). This cycle preferably repeats as long as the overflow sensor 72 detects an overflow of water from the system.

The storage tank 14 comprises a drainage outlet 15 for allowing settled particles to be removed, to prevent build-up of said particles. The drainage outlet 15 is conveniently positioned in the bottom of the tank 14, and is opened and closed by a valve 76, such as a solenoid or rotary valve. The valve 76 is controlled by the control system 20, to open at predetermined intervals for a predetermined period of time. For example, the drainage valve 76 may open for a period of a few seconds or longer, for example 10 seconds to a minute, such as 30 seconds, every few days or longer, for example every other day, every three days, or once a week. In preferred embodiments, the drainage outlet 76 of the storage tank 14 opens every 72 hours for 35 seconds to remove sedimentation.

The water recycling system 10 further comprises a distribution pump 18 for pumping water from the storage tank 14 to the end use, for example a toilet 26. The distribution pump 18 may be any suitable pump, for example operating at 1-2 bar pressure, and is controlled by the control system 20.

The water recycling system 10 comprises a further outlet filter 78 between the distribution pump 18 and the end use. The outlet filter 78 may be of a similar construction to the filters 36, 38 described herein for the filter system 12, and preferably comprises a filter material (not shown in FIG. 1) having an average mesh or pore size which is smaller than that of the filter system 12. Thus, for example, the outlet filter 78 may comprise a filter material having an average mesh size of from 1 to 10 82 m, for example 5 μm. However, the outlet filter 78 preferably comprises an ultrafiltration unit, for example comprising a 20 inch (508 mm) ultrafiltration filter. A typical ultrafiltration membrane pore size may be approximately 0.01×10⁻⁶ m (micron). In the system of the present invention, the particular ultrafiltration membrane(s) to be used in the outlet filter 78 will depend on factors such as the source of the water, the solids content, and particle size distribution, as will be understood by a person skilled in the art.

The outlet filter 78 comprises a drainage valve 77 for allowing Settled particles to be removed, to prevent build-up of said particles. The drainage valve 77 is positioned at the bottom of the outlet filter 78, and is controlled by the control system 20, to open at predetermined intervals for a predetermined period of time. For example, the drainage valve 77 may open for a period of a few seconds or longer, for example 10 seconds to a minute, such as 20 or 30 seconds, every few days or longer, for example every other day, every three days, or once a week. In preferred embodiments, the drainage outlet 77 of the outlet filter 78 opens every 72 hours for 20 seconds to remove sedimentation.

In the illustrated embodiment, water is pumped through the outlet filter 78 (as opposed to the filter system 12 filters 36, 38, in through which water is passed under gravity). Water exits the outlet filter 78 at or towards the top of the outlet filter 78, i.e. only when the outlet filter 78 is substantially full of water.

The water recycling system 10 comprises a pressure switch 80 to measure water pressure exiting the system 10, in communication with the control system 20. Thus, for example, when a toilet 26 is flushed the pressure switch 80 will detect a drop in water pressure, which is communicated to the control system 20. The control system 20 may then activate the distribution pump 18 to pump water from the storage tank 14 to the end use, e.g. to the toilet 26, to restore the water pressure. In the illustrated embodiment, the pressure switch 80 is positioned downstream of the outlet filter 78. The pressure switch 80 may be disabled when the low level water sensor is operated.

The water recycling system 10 further comprises a UV light unit 79 through which water passes between the outlet filter 78 and the end use (toilet 26 in the embodiment shown in FIG. 1). The UV unit 79 helps to further purify the water, reducing microbiological contamination, and may comprise a neon UV light. The UV unit 79 may allow for a flow rate of for example 15 litres per minute. The UV unit 79 preferably operates through activation by the control system 20 when the pressure switch 80 detects a drop in water pressure, for example due to the toilet 26 being flushed.

The water recycling system 10 comprises a plurality of flow meters 22, 24 in communication with the control system 20 for measuring flow of water into and through the system 10 and communicating flow data to the control system 20, wherein a first flow meter (not shown in the Figures) is positioned to measure the flow of mains water entering the premises, a second flow meter 24 is positioned to measure the flow of mains water entering the storage tank 14, and a third flow meter 22 is positioned to measure the flow of greywater entering the storage tank 14 from the filter system 12.

Thus, the first flow meter (not shown in the the Figures) is positioned to measure the flow of mains water entering the premises in which the water recycling system 10 is located. For example, the first flow meter may be positioned at the stop tap where water enters the premises from the mains supply. This flow meter informs the user how much water is entering the premises from the mains supply.

In the illustrated embodiment, the second flow meter 24 is positioned upstream of the mains water inlet 16 for the storage tank 14. This flow meter 24 informs the user how much water is being used by the water recycling system 10 from the mains supply.

The third flow meter 22 is positioned to measure the flow of greywater entering the storage tank 14 from the filter system 12. Thus, in the illustrated embodiment the third flow meter 22 is positioned between the second filter 38 and the storage tank 14. This flow meter 22 informs the user how much greywater is entering the storage tank 14, i.e. the amount of greywater being saved.

Each of the flow meters 22, 24 is in communication with the control system 20 to provide the user with feedback regarding the flow of water into and through the system 10.

The water recycling system 10 comprises dosing means for dosing greywater entering the system with a chemical agent, such as a cleansing or purifying agent, for example an antibacterial agent or biocide. The agent is contained within a dosing reservoir 82. In this way, greywater entering the system may be pre-treated to kill bacteria and remove other impurities.

Dosing with a chemical agent is triggered by an inlet sensor 84 to sense water entering the system. The inlet sensor 84 is positioned upstream from the filter system 12.

The amount of chemical agent to be added to the greywater entering the system 10 depends, in part, on the flow rate of water. For example, the operation of a shower may cause a relatively low flow rate of water, whereas discharging a bath may result in a relatively high flow rate of water. The inlet sensor 84 thus senses the flow rate of greywater entering the system 10. In the illustrated embodiment, the inlet sensor 84 comprises a frequency driven flow meter, which generates a signal according to the flow rate and communicates with the control system 20 to deliver an appropriate amount of chemical agent for that flow rate. For example, the flow meter may be configured to sense “low”, “medium” and “high” flow rates.

The dose of agent to be released will depend upon the agent in question and the desired result, but will typically be from 1 to 20 ppm, for example 10 ppm, of greywater (for example, 0.005 ml of agent per litre of greywater).

In addition, the inlet sensor 84 may be used to trigger a purge of the system 10 if no water at all is detected entering the system 10 for a predetermined period of time, for example period of a few hours to a few days, e.g. 24-36 hours. The inlet sensor 84 can thus be used to trigger partial or complete emptying the filter system 12 and/or the storage tank 14 in the event that it detects no water for a predetermined period of time. Preferably, a total system 10 purge is followed by the storage tank 14 being filled with water from an alternative source, such as mains water, so it will contain sufficient water for a predetermined number of toilet flushes.

The water recycling system 10 comprises a bypass valve 86 at the system inlet which can be operated to bypass the system 10 entirely, so that all greywater flows directly to waste. This may be necessary or desirable, for example, to prevent heavily contaminated water from entering the system 10, or in the event of a system 10 failure. The bypass valve 86 may be operated by a user remotely, for example via a remote switch (not shown in the Figures). For example, a remote switch may be positioned in the bathroom of a premises. Pressing the remote switch may open the bypass valve 86 for a predetermined period of time, for example 10 minutes. In the event of the bypass valve 86 being opened by the control system 20 due to a system fault, the bypass valve 86 preferably remains open until the fault has been rectified.

The water recycling system 10 comprises a control system 20 for controlling operation of the system 10. The control system 20 may be set up or programmed to perform certain actions at regular time intervals, such as a regular partial or complete purge of the filter system 12 and/or storage tank 14 for the removal of settled solids; other actions in response to activation of a sensor, such as the inlet flow sensor 84, water level sensor (not shown in the Figures), and overflow sensor 72 described above; or actions in response to ad hoc manual requests, such as an emergency partial or complete purge of the system 10 in the event of contamination, or system 10 shutdown.

The flow meters 22, 24 communicate with the control system 20, and provide flow data for the system 10. The control system 20 preferably comprises a user interface (not shown in the Figures), such as a display, for presenting the flow data to a user. The control system 20 may store the data, and may be accessible by a user via a remote device, for example a mobile device such as a phone or tablet using appropriate application software. For example, the display may show the amount of greywater saved by the system 10, the amount of potable water used by the system 10, and/or the potable water entering the premises. The control system 20 may provide the user with information regarding the condition of the system 10, such as chemical agent/biocide levels, mains water pressure, and failure conditions.

The control system 20 is preferably configured to perform certain actions in the event of a system failure. For example, the main bypass valve 86 may be operated, to bypass all greywater directly to waste. The fail condition may be triggered if the chemical agent/biocide reservoir is empty, if no mains water pressure is detected as a back-up, or in the event of failure of the distribution pump 18.

The control system 20 may be configured to shut down the system 10 for a predetermined period on demand by a user, for example in the event that the system will not be used for a period of time (e.g. the user is going on holiday), for example three or more days. In the event that the user initiates a temporary system shut down, the control system 20 may be configured to empty the filter system 12 and the storage tank 14, and open the mains water inlet 16 to the storage tank 14 to clean the tank 14 and fill it to the minimum level for the desired end use, e.g. for the toilets 26 to flush. The main bypass valve 86 will also open. When desired, such as on returning from holiday, the user can cancel the temporary system shut down, and the control system 20 returns the water recycling system to normal operation.

The various components of the illustrated system 10 may be made from any suitable components, such as pipes of suitable diameter and thickness, and tanks of suitable volumes. For example, the first and second filters 36, 38 may each have a volume of from 20 to 30 litres each, for example 25 or 28 litres. The storage tank 14 may have a volume, for example, of 75 to 100 litres. For example, a storage tank 14 having dimensions of 525×200×850 mm will have a volume of approximately 89.25 litres. The low water level sensor described above in the storage tank 14 may be positioned, for example, so that it is triggered when the water level in the tank 14 has decreased to, for example, 50% of the maximum volume of the tank 14.

Thus, in use of illustrated embodiment of the system 10, greywater flows from a bath or shower (source A) through the inlet sensor 84. The greywater may have already passed through a suitable filter prior to arriving at the inlet sensor 84. The inlet sensor 84 triggers dosing of the greywater with a suitable amount of chemical agent according to the flow rate of the water which is sensed. The dosed greywater flows into the inner volume 40 of the first filter 36 and, as the first filter 36 fills, water passes through the first filter filter material 44, into the outer volume 42, and then out of the outlet 46 in the first filter outer volume 42 and into the inner volume 54 of the second filter 38. The water then passes through the second filter filter material 58, into the second filter outer volume 56, and as the second filter 38 continues to fill, water passes out of the outlet 30 in the second filter outer volume 56, and into the storage tank 14. A low level sensor (not shown) in the storage tank 14 senses when the water level decreases to a predetermined level, for example 50% of the storage tank 14 volume, which may trigger the control system 20 to release water from the filter system 12 to top-up the storage tank 14. Mains water may be used to top up the storage tank 14, to ensure that water is always available for the end use. An overflow sensor 72 senses when the system 10 is full, and triggers the control system 20 to partially or completely purge “old” water from the system, to be replaced with “new” water, to reduce bacterial growth.

It will be appreciated that the embodiment illustrated above describes the invention for the purposes of illustration only. In practice the invention may be applied to many different configurations, the detailed embodiments being straightforward for those skilled in the art to implement.

1. A water recycling system for use in a premises which comprises;
a filter system for receiving greywater from a greywater source and filtering the greywater;
a storage tank for receiving and storing water from the filter system, the storage tank comprising a mains water inlet for receiving mains water;
a distribution pump for pumping water from the storage tank to an end use;
a control system for controlling operation of the system;
and a plurality of flow meters in communication with the control system for measuring flow of water into and through the system and communicating flow data to the control system;
wherein a first flow meter is positioned to measure the flow of mains water entering the premises, a second flow meter is positioned to measure the flow of mains water entering the storage tank, and a third flow meter is positioned to measure the flow of water entering the storage tank from the filter system.

2. The water recycling system according to claim 1, wherein the filter system comprises a first filter having a first average mesh or pore size for receiving water from the greywater inlet, and a second filter having a second average mesh or pore size for receiving water from the first filter, the second average mesh or pore size being smaller than the first average mesh or pore size;
wherein one or both of the first and second filters comprises a housing having an inner volume and an outer volume surrounding and in fluid communication with the inner volume, wherein in use greywater entering the filter passes firstly into the inner volume, then through a filter medium, and then into the outer volume.

3-5. (canceled)

6. The water recycling system according to claim 1, wherein the filter system is configured so that water only passes from the filter system to the storage tank when the filter system is substantially full of water.

7. The water recycling system according to claim 1, wherein the filter system comprises one or more drainage outlets for allowing the removal of settled particles, wherein each drainage outlet is opened and closed by a valve controlled by the control system and is configured to open at predetermined intervals for a predetermined period of time.

8. (canceled)

9. The water recycling system according to claim 1, wherein the control system is configured to fully or partially empty the system of water as a consequence of an event selected from a lack of water entering the system, an overflow of water from the system, a regular event occurring at a predetermined time, and a manual request by a user.

10. The water recycling system according to claim 2, wherein the water recycling system is configured so that, during emptying of water from the filter system, water in the outer volume flows back through the filter material into the inner volume for dislodging solids which have built up in the filter.

11. The water recycling system according to claim 1, wherein the storage tank comprises one or more sensors to sense the water level in the storage tank, and wherein the control system is configured to disable the distribution pump if the sensor senses a water level in the storage tank which is below a predetermined minimum threshold.

12. The water recycling system according to claim 1, wherein the storage tank comprises an overflow sensor for sensing water which is overflowing from the system, and wherein the control system is configured to partially or completely empty the system of water when the overflow sensor senses water flowing for a predetermined period of time;
wherein the control system is configured to initiate a cleaning cycle when the overflow sensor senses water flowing for a predetermined period of time, the cleaning cycle comprising repeatedly draining water from the filer system and storage tank until the overflow sensor no longer senses water flowing from the system; and
wherein the filter system comprises first and second filters, and the cleaning cycle comprises draining water from the second filter for a predetermined time period and simultaneously from the storage tank for a predetermined time period, and if the overflow sensor continues to sense water flowing then water is drained from the first filter for a predetermined time period and simultaneously from the storage tank for a predetermined time period, the cycle repeating until the overflow sensor no longer senses water flowing from the system.

13. (canceled)

14. (canceled)

15. The water recycling system according to claim 1, further comprising an outlet filter downstream from the distribution pump, the outlet filter comprising a filter material having an average mesh or pore size which is smaller than the average mesh or pore size of any filter material used in the filter system.

16-19. (canceled)

20. The water recycling system according to claim 1, wherein the first flow meter is positioned at the stop tap where water enters the premises from the mains supply, and the second flow meter is positioned upstream of the mains water inlet for the storage tank.

21. (canceled)

22. The water recycling system according to claim 1, further comprising dosing means for dosing greywater entering the system with a chemical agent.

23. The water recycling system according to claim 22, further comprising a flow meter positioned upstream of the filter system and wherein the control system is configured to dose the greywater entering the system according to flow data received from the flow meter.

24. The water recycling system according to claim 23, wherein the control system is additionally or alternatively configured to partially or completely empty the system of water when the inlet sensor measures no water entering the system for a predetermined period of time.

25. The water recycling system according to claim 1, further comprising a bypass valve at the system inlet which is capable of being operated so that no greywater enters the filter system and instead flows directly to waste;
wherein the water recycling system is configured so that the bypass valve may be operated by a user remotely, and/or automatically by the control system in the event of a system fault.

26. (canceled)

27. The water recycling system according to claim 1, further comprising a user interface for presenting flow data to a user.

28. The water recycling system according to claim 1, wherein the control system stores data which may be accessed by a user via a remote device; and
wherein the data is selected from the amount of greywater saved by the system, the amount of potable water used by the system, the potable water entering the premises, and/or information regarding the condition of the system.

29. (canceled)

30. The water recycling system according to claim 1, wherein the control system is configured to shut down the system for a predetermined period on demand by a user in the event that the system will not be used for a period of time, and wherein in response to said shut down request by a user the control system empties the filter system and the storage tank, open the mains water inlet to the storage tank to fill it to the minimum level for the desired end use.

31. A control system for controlling operation of the water recycling system according to claim 1, wherein the control system is configured to perform one or more of the following:
a partial or complete purge of the filter system and/or storage tank for the removal of settled solids;
actions in response to activation of the inlet flow sensor, water level sensor, and/or overflow sensor
actions in response to ad hoc manual requests, including an emergency partial and/or complete purge of the system;
and wherein the control system is also configured to communicate with the flow meters to provide flow data to the system.

32. The control system according to claim 31, further comprising one or more features selected from the group consisting of:
the control system further comprises a user interface for presenting the flow data to a user;
the control system is further configured to store the flow data and to be accessible by a user via a remote device;
the control system is further configured to open the main bypass valve to bypass all greywater directly to waste in the event of a system failure; and
the control system is further configured to shut down the system for a predetermined period on demand by a user.

33-36. (canceled)

37. The control system according to claim 32, wherein the control system is configured to, in the event of an on-demand shut down by a user, empty the filter system and the storage tank, open the mains water inlet to the storage tank to clean the tank and fill it to the minimum level for the desired end use, and open the main bypass valve.
